(19) United States
(12) Patent Application Publication
(10) Pub. No.: US 2025/0296318 A1
(43) Pub. Date: Sep. 25, 2025

(54) LIQUID DISCHARGE HEAD, HEAD MODULE, AND LIQUID DISCHARGE APPARATUS

(71) Applicant: Teppei KANNO, Kanagawa (JP)

(72) Inventor: Teppei KANNO, Kanagawa (JP)

(21) Appl. No.: 19/083,434

(22) Filed: Mar. 19, 2025

(30) Foreign Application Priority Data
Mar. 22, 2024 (JP) 2024-046653

(51) Int. Cl. B41J 2/045; B41J 2/14

(52) U.S. Cl. CPC B41J 2/04526; B41J 2/1433; B41J 2/04581

(57) ABSTRACT

A liquid discharge head includes a nozzle plate having multiple nozzles to discharge a liquid in a discharge direction and multiple suction holes to suck gas in a suction direction opposite to the discharge direction.

### CROSS-REFERENCE TO RELATED APPLICATION

This patent application is based on and claims priority pursuant to 35 U.S.C. § 119 (a) to Japanese Patent Application No. 2024-046653, filed on Mar. 22, 2024, in the Japan Patent Office, the entire disclosure of which is hereby incorporated by reference herein.

### BACKGROUND

### Technical Field

The present disclosure relates to a liquid discharge head, a head module, and a liquid discharge apparatus.

### Related Art

A liquid discharge head discharges a liquid from nozzles onto a recording medium, and the discharged liquid accurately lands at a predetermined position on the recording medium to form a desired image on the recording medium.

### SUMMARY

The present disclosure described herein provides an improved liquid discharge head including a nozzle plate having multiple nozzles to discharge a liquid in a discharge direction and multiple suction holes to suck gas in a suction direction opposite to the discharge direction.

Further, the present disclosure described herein provides an improved liquid discharge head including a nozzle plate and a suction plate attached to the nozzle plate. The nozzle plate has multiple nozzles to discharge a liquid in a discharge direction. The suction plate has multiple suction holes to suck gas in a suction direction opposite to the discharge direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a plan view of a nozzle face of a liquid discharge head according to an embodiment of the present disclosure;

FIG. 2 is a block diagram illustrating a control configuration for controlling a liquid discharge operation from nozzles and a gas suction operation from suction holes;

FIG. 3 is a block diagram illustrating a configuration of a suction device;

FIG. 4A is a plan view of a nozzle face of a liquid discharge head according to a comparative example;

FIG. 4B is a cross-sectional view of the nozzle face along line A1-A1 of FIG. 4A;

FIG. 5A is a plan view of the nozzle face of the liquid discharge head of FIG. 1;

FIG. 5B is a cross-sectional view of the nozzle face along line A2-A2 of FIG. 5A;

FIG. 5C is a plan view of a nozzle face of a nozzle plate having nozzles and suction holes arranged in a different manner

FIGS. 6A and 6B are other plan views of a nozzle face of a nozzle plate having nozzles and suction holes arranged in a different manner;

FIG. 7 is a diagram illustrating an overall configuration of an inkjet image forming apparatus;

FIG. 8 is a block diagram of a control system of the inkjet image forming apparatus of FIG. 7;

FIG. 9 is an exploded perspective view of a liquid discharge head;

FIG. 10 is a cross-sectional view of the liquid discharge head of FIG. 9 taken in a transverse direction;

FIG. 11 is a plan view of a line head unit;

FIG. 12 is a plan view of a serial head unit; and

FIG. 13 is a schematic diagram of a liquid discharge apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. In the drawings, like reference signs denote like elements, and overlapping descriptions may be simplified or omitted as appropriate. A liquid discharge head that discharges ink as a liquid is described below.

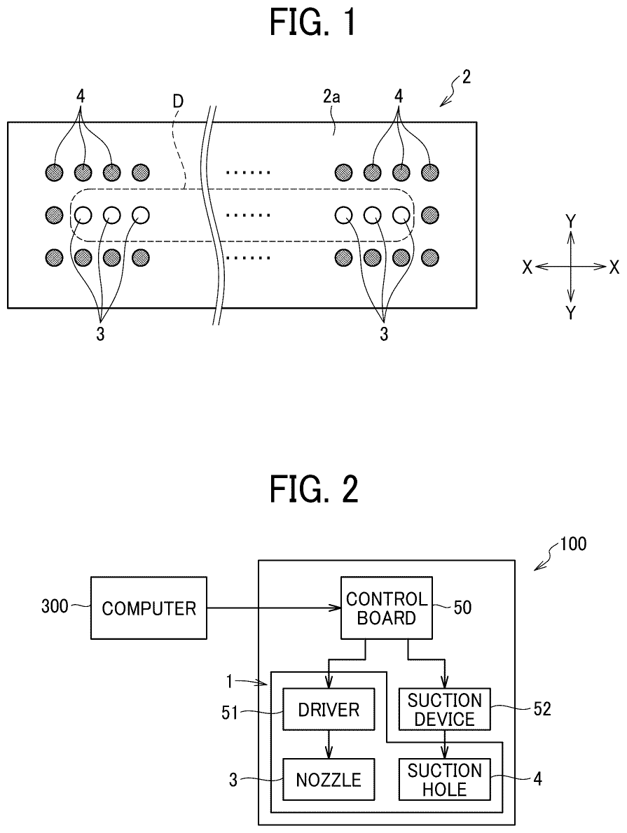

FIG. 1 is a plan view of a nozzle face of a nozzle plate. As illustrated in FIG. 1, the liquid discharge head includes a nozzle plate 2 having a nozzle face 2a from which ink is discharged. On the nozzle face 2a, openings (end portions) of multiple nozzles 3 from which ink is discharged and openings (end portions) of multiple suction holes 4 from which gas is sucked are formed. In FIG. 1, for convenience, the nozzles 3 are indicated by white circles, and the suction holes 4 are indicated by colored circles.

The multiple nozzles 3 are arrayed in the direction X (the left-right direction in FIG. 1) in a space D surrounded by the dashed line in FIG. 1. The direction X is a longitudinal direction of the nozzle face 2a of the nozzle plate 2 and is also an array direction of the nozzles 3. The direction Y in FIG. 1 is a transverse direction of the nozzle face 2a of the nozzle plate 2. The direction from the back to the front of the surface of the paper on which FIG. 1 is drawn is a liquid discharge direction (may be referred to simply as a discharge direction). The ink (liquid) is discharged from the nozzles 3 in the liquid discharge direction. The direction opposite to the liquid discharge direction, i.e., the direction from the front to the back of the surface of the paper on which FIG. 1 is drawn is a suction direction.

The gas is sucked from the suction holes 4 in the suction direction.

The suction hole 4 sucks gas (air). In FIG. 1, the suction holes 4 surround all the nozzles 3 arrayed in the longitudinal direction. The suction holes 4 are disposed adjacent to the nozzles 3 on an outer side of the nozzles 3. In other words, the suction holes 4 are disposed adjacent to the nozzles 3 and closer to the periphery of the nozzle face 2a than the nozzles 3.

FIG. 2 is a block diagram illustrating a control configuration for controlling a liquid discharge operation from the nozzles and a gas suction operation from the suction holes. As illustrated in FIG. 2, a liquid discharge apparatus 100 includes a liquid discharge head 1, a control board 50 as circuitry, and a suction device 52 that performs the gas suction operation to suck gas from the suction holes 4. The liquid discharge head 1 includes a driver 51 that performs the liquid discharge operation to discharge ink from the nozzles 3.

For example, an external computer 300 transmits an instruction to form an image and image data to the control board 50. The control board 50 transmits a pulse signal to the driver 51 based on the received image data to discharge ink from the nozzles 3 by the driving force of the driver 51.

The control board 50 performs the gas suction operation to suck gas from the suction holes 4 in conjunction with the liquid (ink) discharge operation to discharge ink from the nozzles 3. In other words, the control board 50 inputs a pulse signal to the suction device 52 to cause the suction device 52 to perform the suction operation from the suction hole 4. For example, the control board 50 determines whether to perform the suction operation by the suction device 52 based on the amount of liquid discharged from the nozzles 3 per unit time. In other words, the control board 50 calculates the amount of liquid to be discharged per unit time based on the signal input from the computer 300, and inputs a pulse waveform for causing the suction device 52 to perform the suction operation when the amount of the discharged liquid exceeds a predetermined threshold. For example, the predetermined threshold is a value set by the user in advance. For example, when the amount of liquid (ink) discharged from the nozzles 3 near the suction device 52 per unit time exceeds the predetermined threshold, the control board 50 inputs the pulse signal to the suction device 52 to cause the suction device 52 to perform the suction operation. The nozzles 3 near the suction device 52 means the nozzles 3 in an area closest to the suction device 52 from the nozzles 3.

As described above, the suction operation from the suction holes 4 is performed by the suction device 52 which is separated from the driver 51. The driver 51 performs the liquid (ink) discharge operation from the nozzles 3. The control board 50 controls both the operations of the driver 51 and the suction device 52. However, the operations of the driver 51 and the suction device 52 may be controlled by different control units.

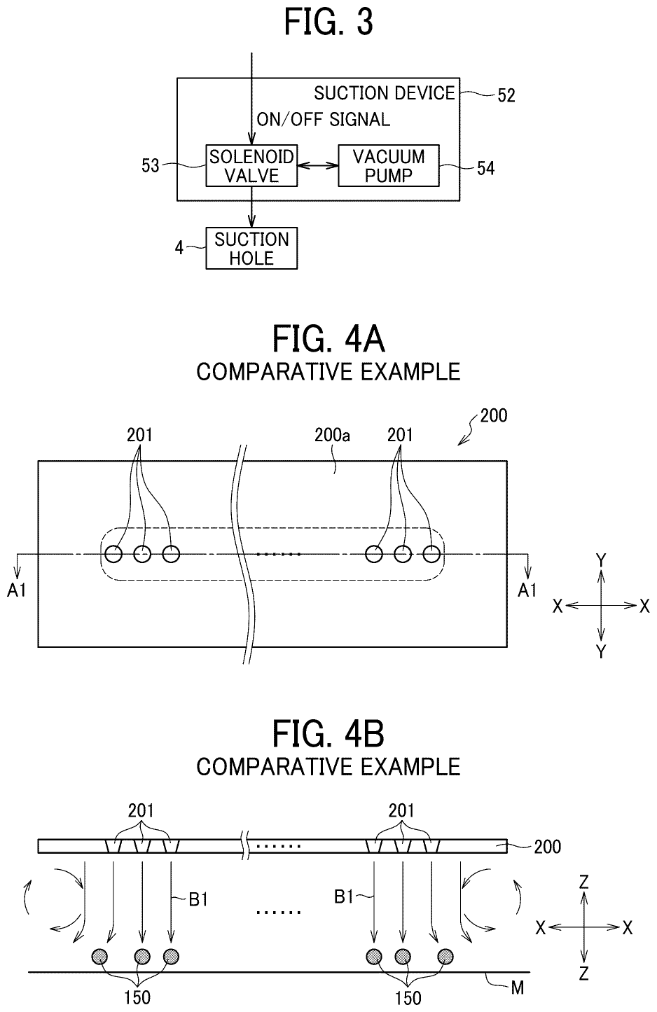

FIG. 3 is a block diagram illustrating a configuration of the suction device 52. As illustrated in FIG. 3, the suction device 52 includes a solenoid valve 53 and a vacuum pump 54. The solenoid valve 53 is an electronically controllable on-off valve. The vacuum pump 54 is operated when the liquid discharge head 1 is used, to keep a reduced pressure in a space where the solenoid valve 53 is mounted. When the solenoid valve 53 is opened by a signal from the control board 50, air is sucked from the suction holes 4 toward the solenoid valve 53 by the reduced pressure in the space where the solenoid valve 53 is mounted.

The solenoid valve 53 and the space where the solenoid valve 53 is mounted are disposed in the liquid discharge head 1. This space is connected to the vacuum pump 54 outside the liquid discharge head 1, for example, via a tube. As described above, components constructing the suction device 52 are disposed in the liquid discharge head 1 and in the liquid discharge apparatus 100 outside the liquid discharge head 1. Alternatively, the suction device 52 may be disposed inside the liquid discharge head 1 or may be disposed only outside the liquid discharge head 1. Such a configuration of the suction device 52 is an example, and a known configuration can be appropriately adopted.

In a liquid discharge head that discharges liquid (e.g., ink) from nozzles, the landing position of the liquid is deviated due to interference of airflow. A liquid discharge head according to a comparative example is described below with reference to FIGS. 4A and 4B. FIG. 4A is a plan view of a nozzle face 200a of a nozzle plate 200 of the liquid discharge head, and FIG. 4B is a cross-sectional view of the nozzle plate 200 along line A1-A1 of FIG. 4A.

As illustrated in FIG. 4A, multiple nozzles 201 are arrayed in a nozzle row extending in the longitudinal direction on the nozzle face 200a of the nozzle plate 200, and the suction holes 4 of FIG. 1 are not provided.

As illustrated in FIG. 4B, in a region where the nozzles 201 are arrayed in the longitudinal direction, ink 150 is discharged downward as indicated by arrows B1 in FIG. 4B, and airflow flowing downward is generated by the ink 150 discharged from the nozzles 201. On the other hand, such an airflow is not generated outside the region where the nozzles 201 are arrayed. Accordingly, in the vicinity of the boundary between the region where the nozzles 201 are arrayed and the outside of the region, a vortex of the airflow circulating in the clockwise (counterclockwise) direction is generated as indicated by arrows illustrated on the left (right) side of FIG. 4B.

A recording medium M such as a sheet is conveyed so as to face the nozzle plate 200. The airflow is also generated by the conveyance of the recording medium M. In particular, when the recording medium M is conveyed in the direction X in FIG. 4B, which is a direction parallel to the longitudinal direction, the airflow circulating in the clockwise (counterclockwise) direction described above is disturbed. The direction indicated by arrows B1 is the liquid discharge direction to discharge the ink 150 when the landing position of the ink 150 illustrated in FIG. 4B is not deviated from a desired landing position.

Due to the influence of the airflow, the landing position of the ink 150 discharged from the nozzle 201 arranged at the end of the nozzle row in the longitudinal direction is deviated outward in the longitudinal direction. Such a deviation may cause an abnormal image such as uneven density or streaks of an image formed on the recording medium M. In particular, in a liquid discharge head having a large printing gap, ink discharged from the nozzles is likely to be affected by the airflow, and the deviation of the landing position of ink due to the influence of the airflow becomes significant. The printing gap is a distance between the nozzle face and the recording medium. For example, the large printing gap is a distance larger than 5 mm.

A certain image processing technique may prevent an abnormal image due to the deviation of the landing position, but image processing may become complicated, or the technique may not be effective for a liquid discharge head having a large printing gap.

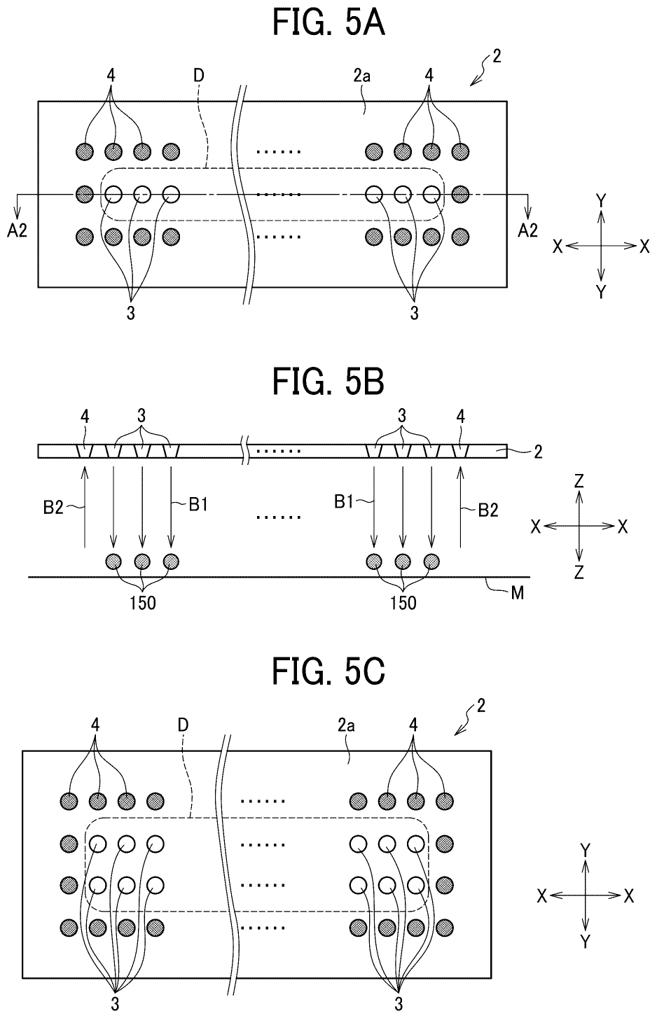

A liquid discharge head according to an embodiment of the present disclosure is described below with reference to FIGS. 5A and 5B. FIG. 5A is a plan view of the nozzle face 2a of the nozzle plate 2 of the liquid discharge head, and FIG. 5B is a cross-sectional view of the nozzle plate 2 along line A2-A2 of FIG. 5A.

As illustrated in FIG. 5A, the suction holes 4 are arranged around the nozzles 3 on the nozzle face 2a. As illustrated in FIG. 5B, the gas is sucked from the suction holes 4 in the direction indicated by arrows B2 in FIG. 5B. In other words, as illustrated in FIG. 5B, an airflow flowing in the direction indicated by arrows B2, which is opposite to the direction indicated by arrows B1, is formed at a position corresponding to the position where the airflow circulating in the clockwise (counterclockwise) direction illustrated in FIG. 4B is formed or the vicinity thereof.

Accordingly, the airflow caused by the ink 150 discharged from the nozzles 3 can be canceled, and the ink 150 discharged from the nozzles 3 can be prevented from being affected by the airflow caused by, for example, the discharge of the ink 150 and the conveyance of the recording medium M. As a result, the deflection of the discharge direction of the ink discharged from the nozzles 3 can be prevented. In particular, the deflection of the discharge direction of the ink discharged from an outermost nozzle 3 can be prevented. In other words, the deviation of the landing position can be reduced. As described above, when the amount of the discharged ink exceeds the threshold, the suction operation is performed by all the suction holes 4 during the liquid discharge operation from the nozzles 3.

In FIG. 5A, the suction holes 4 surround the nozzle row of the nozzles 3, i.e., surround all the multiple nozzles 3. Thus, the airflow flowing toward the suction holes 4 in the direction indicated by arrows B2 can be formed around the periphery of the space D in which the nozzles 3 are arrayed. As described above, the airflow flowing in the direction opposite to the discharge direction of the ink discharged from the nozzles 3 at the boundary between the space D and the outside of the space D can be generated, and thus the ink discharged from each nozzle 3 can be prevented from being affected by the airflow due to the ink discharged from the nozzles 3 or the airflow outside the space D in which the nozzles 3 are disposed, such as the airflow due to the conveyance of the recording medium. As a result, the deviation of the landing position of the ink discharged from the nozzles 3 can be further prevented.

In the above description, the suction holes 4 are disposed adjacent to the nozzles 3 on the outer side of the nozzles 3 on the nozzle face 2a in the direction X and the direction Y, but the positions of the suction holes 4 are not limited thereto. For example, the suction holes 4 may be disposed at a certain distance from the nozzles 3. The term “outside” or “outer side” of the nozzles 3 used herein refers to, when the center of the nozzle face 2a in the direction X and the direction Y is defined as an inside or an inner side and the direction from the center toward the periphery of the nozzle face 2a is defined outward, an area on the outside or outer side from the nozzles 3, i.e., an area closer to the periphery than the nozzles 3 or an area between the periphery and the nozzles 3. Alternatively, the term “outside” or “outer side” of the nozzles 3 refers to, when a region in which the multiple nozzles 3 are arrayed is defined as a nozzle region and the center of the nozzle region in the direction X and the direction Y is defined as the inside or the inner side, an area away from the center of the nozzle region on a plane orthogonal to the liquid discharge direction from the nozzles 3.

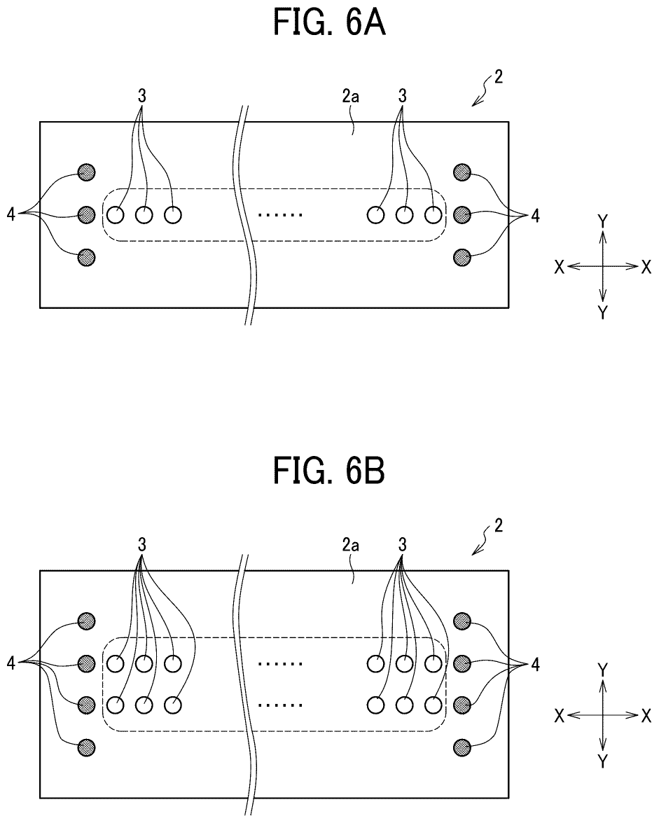

In FIG. 5A, the suction holes 4 are disposed around all the nozzles 3 so as to surround the entire circumference of the nozzle row of the nozzles 3, but the arrangement of the nozzles 3 and the suction holes 4 is not limited thereto. For example, in FIG. 6A, the suction holes 4 are disposed on the outer side from the nozzle row of the nozzles 3 on both sides (i.e., outside each of outermost nozzles) in the direction X. In other words, the suction holes 4 are disposed between each of outermost nozzles 3 of the nozzles 3 and each of transverse sides of the periphery of the nozzle face 2a in the direction X (longitudinal direction). The transvers sides extend in a direction intersecting the longitudinal direction. Although FIG. 6A illustrates the three suction holes 4 on each side, one suction hole 4 may be disposed on each side.

As illustrated in FIG. 4B, the landing positions of the ink discharged from the nozzles 3 at both ends of the nozzle row (i.e., the outermost nozzles) are likely to be deviated from desired landing positions due to the influence of the vortex of the airflows on the outer sides of the nozzle row in the direction X. For this reason, preferably, the suction holes 4 are disposed at both ends of the nozzle row of the nozzles 3. More preferably, the suction holes 4 surround the nozzle row of the nozzles 3 as illustrated in FIG. 1. Alternatively, the suction holes 4 may be disposed in two rows outside the nozzle 3. For example, additional suction holes 4 may surround the suction holes 4 illustrated in FIG. 1.

In FIGS. 5A and 6A, the multiple nozzles 3 are arrayed in one row in the direction X. However, other multiple nozzles may be formed on the nozzle face 2a, and the multiple nozzles 3 and the other multiple nozzles may be arrayed in parallel in two rows (or more) as illustrated in FIGS. 5C and 6B. The arrangement of the suction holes 4 described above can be applied to such cases of multiple nozzle rows as illustrated in FIGS. 5C and 6B.

In the above embodiment, the suction holes 4 are disposed in the nozzle plate 2 in which the nozzles 3 are disposed. However, the suction holes 4 may be formed on another component different from the nozzle plate 2. In this case, for example, as described above, the suction holes 4 may be arranged outside the nozzles 3 on a plane orthogonal to the liquid discharge direction from the nozzles 3. The suction holes 4 formed in the nozzle plate 2 allows the liquid discharge head 1 to be reduced in cost and size as compared to the suction holes 4 formed in another component different from the nozzle plate 2. The suction holes 4 do not adversely affect the maintenance performance of the liquid discharge head 1. As compared with the suction holes 4 formed in another component different from the nozzle plate 2, the wiping operation or the suction operation with respect to the nozzles 3 is not adversely affected, such as becoming complicated, and the suction holes 4 formed in the nozzle plate 2 can be wiped simultaneously by the wiping operation with respect to the nozzles 3.

In the above description, the suction operation is simultaneously performed by all the suction holes 4, but the suction operation is not limited thereto. For example, the suction operation may be performed only by the suction holes 4 near or adjacent to the nozzles 3 discharging ink. Regarding a threshold of a discharge amount of ink (liquid) for performing the suction operation, the discharge amount of ink discharged from all the nozzles 3 may be equally added, or the discharge amount may be weighted, for example, according to the position of each of the nozzles 3. For example, as described above, since the landing positions of the ink discharged from the nozzles 3 at both ends of the nozzle row of the nozzles 3 (i.e., the outermost nozzles) are likely to deviate from desired landing positions, the weighting of the discharge amount of the outermost nozzles 3 can be increased. Thus, the suction operation can be performed when the discharge amount of ink discharged from the outermost nozzles 3 at both ends is large.

A liquid discharge apparatus including the liquid discharge head described above or a head module including multiple liquid discharge heads will be described below.

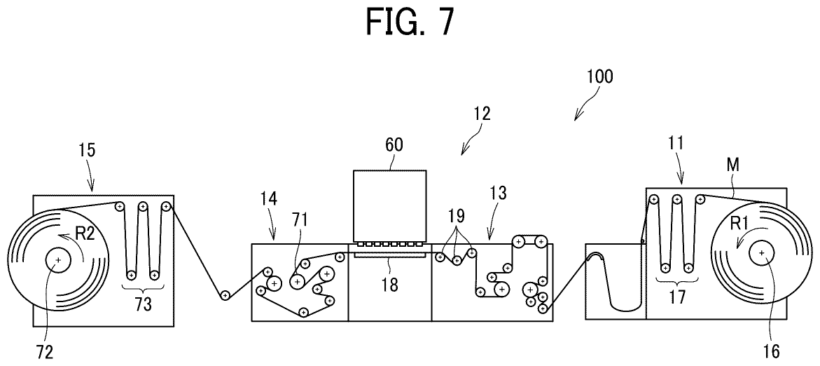

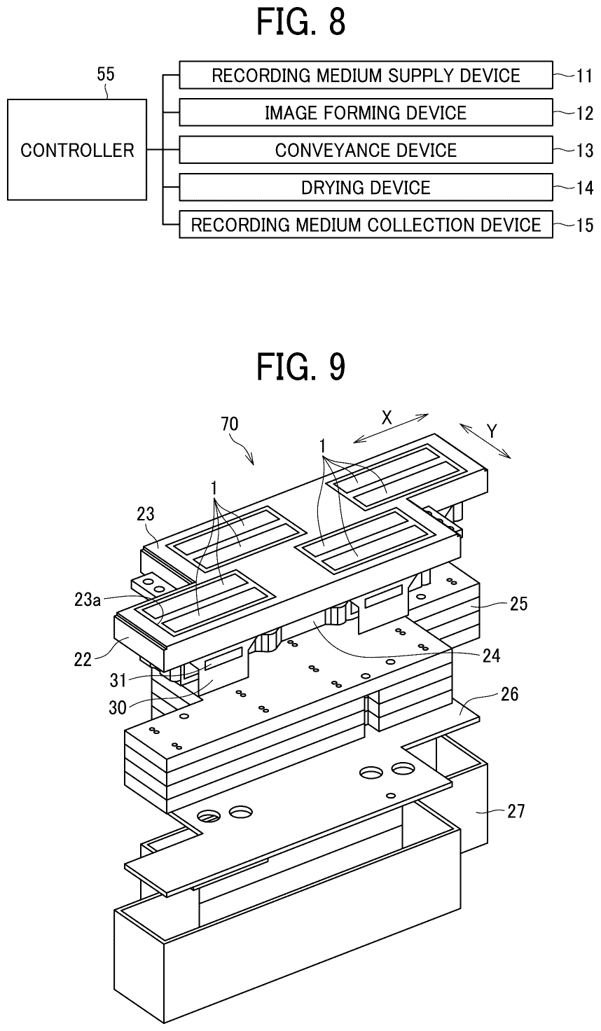

As illustrated in FIG. 7, an image forming apparatus 100 as a liquid discharge apparatus includes a recording medium supply device 11 that supplies a recording medium M for image formation, an image forming device 12 that forms an image on the recording medium M, a conveyance device 13 that conveys the recording medium M to the image forming device 12, a drying device 14 that dries the recording medium M, and a recording medium collection device 15 that collects the recording medium M on which the image is formed. The image forming apparatus 100 further includes a controller 55 (see FIG. 8) that controls the recording medium supply device 11, the image forming device 12, the conveyance device 13, the drying device 14, and the recording medium collection device 15.

The controller 55 may include the control board 50 illustrated in FIG. 2.

The recording medium supply device 11 includes a supply roller 16 around which the long recording medium Mis wound in a roll shape, and a tension adjustment mechanism 17 that adjusts tension applied to the recording medium M. The supply roller 16 is rotatable in the direction indicated by arrow R1 illustrated in FIG. 7, and the recording medium Mis fed from the supply roller 16 as the supply roller 11 rotates. The tension adjustment mechanism 17 includes multiple rollers between which the recording medium M is stretched to apply tension to the recording medium M. Some of the multiple rollers move to adjust the tension of the recording medium M, and the recording medium Mis fed from the supply roller 16 with a constant tension.

The image forming device 12 includes a head unit 60 as a liquid discharge unit that discharges ink (i.e., a liquid) onto the recording medium M, and a platen 18 as a recording medium support that supports the recording medium M being conveyed. The head unit 60 includes multiple liquid discharge heads. Each of the multiple liquid discharge heads discharges ink onto the recording medium M based on image data generated by the controller 55 to form an image on the recording medium M. The ink is a liquid containing a colorant, a solvent, and crystalline resin particles dispersed in the solvent. The crystalline resin changes a phase thereof and melts from a crystal to a liquid when heated above a melting point thereof. The platen 18 faces the head unit 60 and supports the lower surface (back surface) of the recording medium M supplied from the recording medium supply device 11. The platen 18 approaches and separates from the head unit 60 so as to keep the distance between the head unit 60 and the recording medium M constant.

The conveyance device 13 as a conveyor includes multiple conveyance rollers 19. The recording medium M is conveyed to the image forming device 12 by the rotation of the conveyance rollers 19 while being stretched between the conveyance rollers 19. The conveyance device 13 may include other conveyors such as a conveyance belt.

The drying device 14 includes a heating drum 71 that heats the recording medium M to dry ink on the recording medium M. The heating drum 71 has a cylindrical shape and rotates while the recording medium M is wound around the outer circumferential surface thereof, and a heating source such as a halogen heater is disposed inside the heating drum 71. A non-contact heating unit such as a hot air generating device that blows hot air to the recording medium M can be used as a heating unit to heat the recording medium M in addition to a contact heating unit such as the heating drum 71.

The recording medium collection device 15 includes a collection roller 72 that winds and collects the recording medium M, and a tension adjustment mechanism 73 that adjusts tension applied to the recording medium M. The collection roller 72 is rotatable in the direction indicated by arrow R2 illustrated in FIG. 7, and the recording medium Mis wound in a roll shape around the collection roller 72 as the collection roller 17 rotates. The tension adjustment mechanism 73 includes multiple rollers, similarly to the tension adjustment mechanism 17 of the recording medium supply device 11. Some of the multiple rollers move to adjust the tension of the recording medium M, and the recording medium Mis wound up by the collection roller 72 with a constant tension.

The controller 55 includes an information processor such as a personal computer (PC). The controller 55 generates the image data to be formed on the recording medium M, and controls various operations of the recording medium supply device 11, the image forming device 12, the conveyance device 13, the drying device 14, and the recording medium collection device 15. For example, the controller 55 controls the temperatures of the heating source that heats the heating drum 71 in addition to the rotation speeds of the supply roller 16, the collection roller 72, and the conveyance rollers 19.

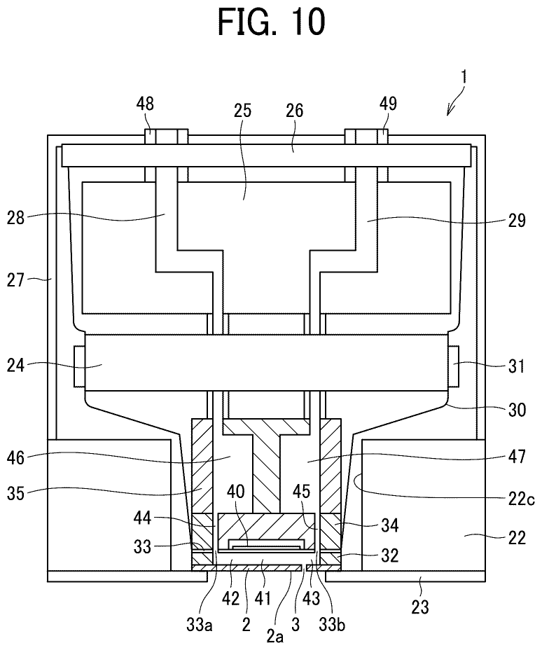

A head module including multiple liquid discharge heads will be described below with reference to FIGS. 9 and 10. FIG. 9 is an exploded perspective view of the head module, and FIG. 10 is a cross-sectional view of the head module illustrated in FIG. 9 in a transverse direction of the head module (the direction Y indicated by arrow Y in FIG. 9).

As illustrated in FIG. 9, a head module 70 includes multiple liquid discharge heads 1, a base 22, a cover 23, a heat dissipator 24, a manifold 25, a printed circuit board (PCB) 26, and a module case 27.

The base 22 as a holder holds the multiple liquid discharge heads 1. In order to attach the liquid discharge head 1 to the base 22, first, the liquid discharge head 1 is inserted into an opening 22c (see FIG. 10) formed in the base 22. Then, the liquid discharge head 1 is bonded to the cover 23 bonded to the base 22. The cover 23 has a hole 23a (see FIG. 9) corresponding to the liquid discharge head 1, and a peripheral area of the liquid discharge head 1 is bonded to an inner edge of the hole 23a. The liquid discharge head 1 is fixed to the base 22 with screws. Specifically, a common channel substrate 35 (see FIG. 10) has flanges on the front side and the back side in the longitudinal direction (direction orthogonal to the surface of the paper on which FIG. 10 is drawn) of the liquid discharge head 1, and the flanges are fastened to the base 22 with screws. Thus, the base 22 holds the common channel substrate 35 to fix the liquid discharge head 1. The structure for attaching the liquid discharge head 1 to the base 22 is not limited to the above structure, and the liquid discharge head 1 may be attached by, for example, adhesion, caulking, swaging, or riveting.

As illustrated in FIG. 10, the liquid discharge head 1 includes the nozzle plate 2 having the nozzles 3, a channel substrate 32 defining individual liquid chambers 41 communicating with the nozzles 3, a diaphragm 33 including a piezoelectric element 40, a holding substrate 34 laminated on the diaphragm 33, and the common channel substrate 35 as a frame laminated on the holding substrate 34. The diaphragm 33 including the piezoelectric element 40 is included in a driver that performs the discharge operation to discharge ink from the nozzles 3 described above.

In addition to the individual liquid chambers 41, the channel substrate 32 defines supply-side individual channels 42 communicating with the individual liquid chambers 41 and collection-side individual channels 43 communicating with the individual liquid chambers 41, respectively. The holding substrate 34 defines supply-side intermediate individual channels 44 and collection-side intermediate individual channels 45. The supply-side intermediate individual channels 44 communicate with the supply-side individual channels 42 via openings 33a of the diaphragm 33, respectively. The collection-side intermediate individual channels 45 communicate with the collection-side individual channels 43 via openings 33b of the diaphragm 33, respectively.

The common channel substrate 35 (i.e., the frame) defines a supply-side common channel 46 and a collection-side common channel 47. The supply-side common channel 46 communicates with the supply-side intermediate individual channels 44. The collection-side common channel 47 communicates with the collection-side intermediate individual channels 45. The supply-side common channel 46 communicates with a supply port 48 via a channel 28 of the manifold 25. The collection-side common channel 47 communicates with a collection port 49 via another channel 29 of the manifold 25.

The PCB 26 and the piezoelectric element 40 of the liquid discharge head 1 are connected via a flexible wiring board 30. A driver integrated circuit (IC) 31 is mounted on the flexible wiring board 30.

The base 22 is preferably made of a material having a small linear expansion coefficient. Examples of the material having a small linear expansion coefficient include 42Alloy which is an alloy of iron with nickel and an invar material. With the base 22 made of such a material, even when the temperature of the base 22 is increased by heat generated by the liquid discharge head 1, the amount of expansion of the base 22 is small, and thus the positional deviation of the nozzles is unlikely to occur. As a result, the positional deviation of the discharged ink can be reduced. Further, by forming the nozzle plate 2 and the diaphragm 33 from a silicon single crystal substrate and setting the linear expansion coefficient of the nozzle plate 31 and the diaphragm 33 to be substantially the same as that of the base 22, the positional deviation of the nozzles due to thermal expansion can be reduced.

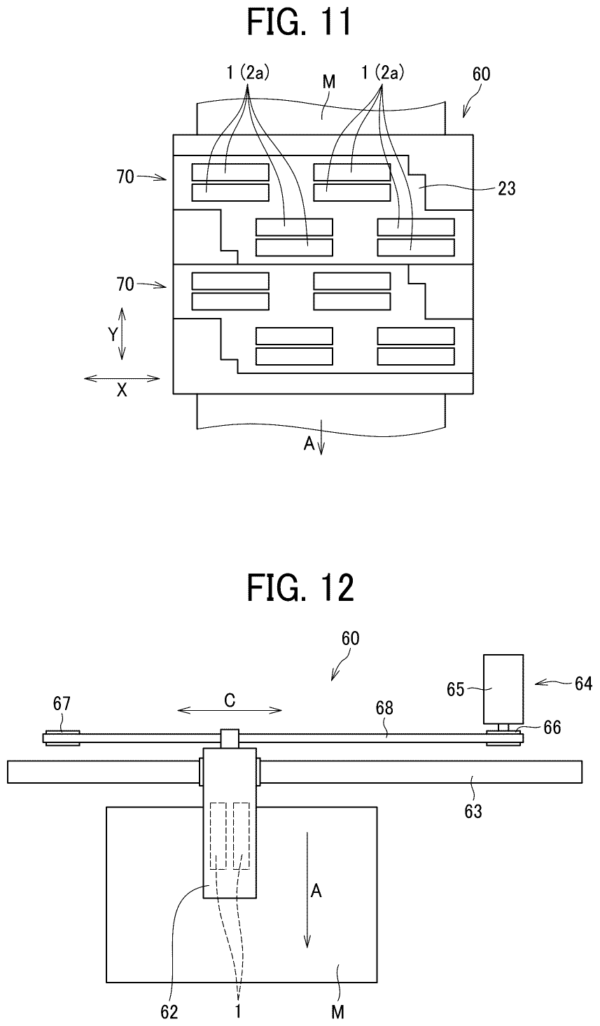

FIG. 11 is a plan view of a head unit. As illustrated in FIG. 11, the head unit 60 includes two head modules 70. The transverse direction (i.e., the direction Y indicated by arrow Y) of each head module 70 is aligned with a conveyance direction A of the recording medium M indicated by arrow A, and the longitudinal direction (the direction X indicated by arrow X) of each liquid discharge head 20 is aligned with a direction orthogonal to the conveyance direction A. As illustrated in FIG. 11, the “longitudinal direction” of the head module 70 means the longitudinal direction (direction X indicated by arrow X) in which the head module 70 extends in one direction when viewed in a direction orthogonal to the nozzle face 2a on which the nozzles 3 (see FIG. 10) are exposed. The “transverse direction” of the head module 70 means a direction (direction Y indicated by arrow Y) orthogonal to the longitudinal direction of the head module 70 when viewed in the direction orthogonal to the nozzle face 2a. The longitudinal direction (direction X) and the transverse direction (direction Y) are also a longitudinal direction and a transverse direction of the nozzle face 2a of the nozzle plate 2, respectively. The “longitudinal direction” and the “transverse direction” of the head module 70 described in the following description have the same meaning. In the present embodiment, the longitudinal direction (direction X) is orthogonal to the conveyance direction A of the recording medium M, and the transverse direction Y is parallel to the conveyance direction A of the recording medium M, but the transverse direction may be orthogonal to the conveyance direction A and the longitudinal direction may be parallel to the conveyance direction A.

The head unit 60 illustrated in FIG. 11 is a so-called line head unit. When the recording medium Mis conveyed to a position facing the head unit 60, the head unit 60 does not move and discharges ink from the nozzles 3 of the liquid discharge heads 1 to the recording medium M being conveyed to form an image on the recording medium M.

In addition to the line head unit, a so-called serial head unit that discharges ink while moving the liquid discharge head in a main scanning direction (i.e., a width direction of the recording medium M) can be used.

FIG. 12 is a plan view of a serial head unit 60. As illustrated in FIG. 12, the serial head unit 60 includes a carriage 62 on which liquid discharge heads 1 are mounted, a guide (guide rod) 63 that guides the carriage 62 in the main scanning direction, which is the width direction C of the recording medium M indicated by arrow C, and a driver 64 that moves the carriage 62.

The driver 64 includes a motor 65 serving as a driving source and a timing belt 68 looped around a drive pulley 66 and a driven pulley 67. As the motor 65 is driven and the drive pulley 66 is rotated, the timing belt 68 circumferentially moves. Accordingly, the carriage 62 is moved in the main scanning direction along the guide 63. As the rotation direction of the motor 65 is switched between one direction and the opposite direction, the carriage 62 reciprocates in the main scanning direction.

In the serial head unit 60, the liquid discharge heads 1 discharge ink in response to image signals while the carriage 62 moves in the main scanning direction. By so doing, an image for one line is formed on the recording medium M not in motion. The reciprocal movement of the carriage 62 and the discharge of the ink are repeatedly performed while the recording medium Mis intermittently moved by a predetermined amount in the conveyance direction A of the recording medium M indicated by arrow A in FIG. 12. By so doing, an image is sequentially formed on the recording medium M.

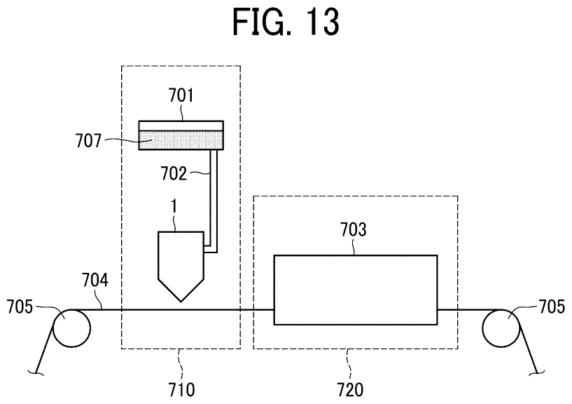

As a liquid discharge apparatus including the liquid discharge head or the head module, an electrode manufacturing apparatus that manufactures an electrode and an electrochemical element will be described below with reference to FIG. 13.

FIG. 13 is a schematic view of an electrode manufacturing apparatus. The electrode manufacturing apparatus is an apparatus for manufacturing an electrode including a layer containing an electrode material by discharging a liquid composition using a head module including a liquid discharge head. A discharge device in the electrode manufacturing apparatus illustrated in FIG. 13 is the head module according to the above-described embodiments of the present disclosure. The liquid discharge head of the head module discharges a liquid composition. By so doing, the liquid composition is applied onto an object, and a liquid composition layer is formed on the object. The object, which may also be referred to as a discharge target in the following description, is not limited to any particular object and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector. The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

Other configurations included in the electrode manufacturing apparatus for manufacturing an electrode composite layer are not limited to any particular configuration and may be appropriately selected depending on the intended purpose, as long as the effects of the present embodiment are not impaired. Other processes included in the method for manufacturing an electrode composite layer are not limited to any particular process and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

As an example of the electrode manufacturing apparatus, an electrode manufacturing apparatus that forms an electrode composite layer containing an active material on an electrode substrate, i.e., a current collector, is described below. As illustrated in FIG. 13, the electrode manufacturing apparatus includes a discharge process device 710 and a heating process device 720. The discharge process device 710 performs a discharge process of applying a liquid composition onto a print base material 704 having a discharge target to form a liquid composition layer. The heating process device 720 performs a heating process of heating the liquid composition layer to obtain an electrode composite layer.

The electrode manufacturing apparatus includes a conveyor 705 that conveys the print base material 704. The conveyor 705 conveys the print base material 704 to the discharge process device 710 and the heating process device 720 in this order at a preset speed. A method of producing the print base material 704 having the discharge target such as an active material layer is not limited to any particular method, and a known method can be appropriately selected. The discharge process device 710 includes the liquid discharge head 1 that performs an application process of applying a liquid composition 707 onto the print base material 704, a storage container 701 that stores the liquid composition 707, and a supply tube 702 that supplies the liquid composition 707 stored in the storage container 701 to the liquid discharge head 1.

The discharge process device 710 discharges the liquid composition 707 from the liquid discharge head 1 so that the liquid composition 707 is applied onto the print base material 704 to form a liquid composition layer in a thin film shape. The storage container 701 may be integrated with the electrode manufacturing apparatus that forms the electrode composite layer or may be detachable from the electrode manufacturing apparatus. The storage container 701 may be a container additionally attachable to a container integrated with the electrode manufacturing apparatus for manufacturing the electrode composite layer or to a container detachable from the electrode manufacturing apparatus for manufacturing the electrode composite layer. The storage container 701 that stably stores the liquid composition 707 and the supply tube 702 that stably supplies the liquid composition 607 can be used.

The heating process device 720 performs a solvent removal process of heating and removing the solvent remaining in the liquid composition layer. Specifically, the solvent that remains in the liquid composition layer is heated and dried by a heater 703 of the heating process device 720. Accordingly, the solvent is removed from the liquid composition layer. Thus, the electrode composite layer is formed. The heating process device 720 may perform the solvent removing process under reduced pressure.

The heater 703 is not limited to any particular heater and may be appropriately selected depending on the intended purpose. For example, the heater 703 may be a substrate heater, an infrared (IR) heater, or a hot air heater. The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

The electrode manufacturing apparatus according to the present embodiment is used to discharge the liquid composition to a desired position on the discharge target. The electrode composite layer can be suitably used, for example, as a part of the configuration of an electrochemical element. The configuration of the electrochemical element other than the electrode composite layer is not limited to any particular configuration, and a known configuration can be appropriately selected. Examples of the configuration other than the electrode composite layer include a positive electrode, a negative electrode, and a separator.

The head module or the liquid discharge apparatus using the liquid discharge head described above can reduce the deviation of the landing position of the liquid.

The above-described embodiments are illustrative and do not limit the present disclosure. Numerous additional modifications and variations are possible in light of the above teachings. It is therefore to be understood that within the scope of the appended claims.

In the present disclosure, the liquid to be discharged is not limited to a particular liquid as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. Examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

The term “liquid” includes not only ink but also paint, a pretreatment liquid, a binder, and an overcoat liquid.

In the present disclosure, the term “liquid discharge apparatus” includes a carriage including a liquid discharge head and drives the liquid discharge head to discharge liquid. The term “liquid discharge apparatus” used herein includes, in addition to apparatuses to discharge liquid to a recording medium serving as a medium onto which liquid can adhere, apparatuses to discharge liquid into gas (air) or different liquid.

For example, the “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. The medium onto which liquid can adhere corresponds to the recording medium in the above embodiments. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

The terms “image formation,” “recording,” “printing,” “image printing,” and “fabricating” used herein may be used synonymously with each other.

Aspects of the present disclosure are, for example, as follows.

### Aspect 1

A liquid discharge head includes multiple nozzles to discharge a liquid and suction holes to suck gas in a direction opposite to a liquid discharge direction from the nozzles.

In other words, a liquid discharge head includes a nozzle plate having multiple nozzles to discharge a liquid in a discharge direction and multiple suction holes to suck gas in a suction direction opposite to the discharge direction.

### Aspect 2

The liquid discharge head according to Aspect 1, further comprising a nozzle member having the nozzles and the suction holes.

In other words, the nozzle plate has the multiple nozzles on a nozzle face of the nozzle plate, and the multiple nozzles are arrayed in a longitudinal direction orthogonal to the discharge direction.

In addition, the nozzle plate may further have other multiple nozzles on a nozzle face of the nozzle plate. The other multiple nozzles are arrayed parallel to the multiple nozzles and in the longitudinal direction.

### Aspect 3

In the liquid discharge head according to Aspect 2, the suction holes are disposed at a position adjacent to the nozzles on an outer side of the nozzles on a nozzle face of the nozzle member. The nozzle face has an end portion of the nozzles on a liquid discharge side of the nozzles.

In other words, the multiple suction holes are adjacent to the multiple nozzles in the longitudinal direction and a transverse direction orthogonal to the longitudinal direction and the discharge direction, and are outside the multiple nozzles in the longitudinal direction and the transverse direction.

### Aspect 4

In the liquid discharge head according to Aspect 2 or 3, the suction holes are disposed outside the nozzles arranged closest to both ends in an array direction of the nozzles.

In other words, the multiple suction holes are disposed outside each of outermost nozzles of the multiple nozzles in the longitudinal direction.

### Aspect 5

In the liquid discharge head according to Aspect 2 or 3, the suction holes are disposed so as to surround the multiple nozzles arranged.

In other words, the multiple suction holes surround entire circumference of the multiple nozzles arrayed on the nozzle face of the nozzle plate.

### Aspect 6

In the liquid discharge head according to any one of Aspect 1 to 5, the presence or absence of a suction operation by the suction holes is changed depending on a discharge amount of the liquid discharged from the nozzles.

In other words, in the liquid discharge apparatus according to Aspect 9, the circuitry controls the vacuum pump to suck the gas from the multiple suction holes or controls the vacuum pump not to suck the gas from the multiple suction holes based on a discharge amount of the liquid discharged from the multiple nozzles.

### Aspect 7

A head module includes the liquid discharge head according to any one of Aspects 1 to 6.

In other words, a head module includes multiple liquid discharge heads including the liquid discharge head according to any one of Aspects 1 to 6.

### Aspect 8

A liquid discharge apparatus includes the liquid discharge head according to any one of Aspects 1 to 6.

In other words, a liquid discharge apparatus includes the liquid discharge head according to any one of Aspects 1 to 6, to discharge the liquid to a medium and a conveyor to convey the medium to the liquid discharge head.

### Aspect 9

The liquid discharge apparatus according to Aspect 8, further includes a suction device to perform a suction operation by the suction holes and a controller to control the suction operation by transmitting a signal to the suction device.

In other words, a liquid discharge apparatus includes the liquid discharge head according to any one of Aspects 1 to 6, a vacuum pump to suck the gas from the multiple suction holes, and circuitry configured to control the vacuum pump to suck the gas from the multiple suction holes.

### Aspect 10

The liquid discharge apparatus according to Aspect 9, further includes a driver to perform a discharge operation of the liquid from the nozzles. The driver is separated from the suction device.

In other words, the liquid discharge head includes a driver to discharge the liquid from the multiple nozzles.

### Aspect 11

The liquid discharge apparatus according to Aspect 9 or 10, the controller controls a discharge operation of the liquid from the nozzles.

In other words, the circuitry controls the driver to discharge the liquid from the multiple nozzles.

### Aspect 12

In the liquid discharge apparatus according to Aspect 9, the circuitry controls the vacuum pump to suck the gas to cancel an airflow generated by the liquid discharged from the multiple nozzles.

### Aspect 13

In the liquid discharge apparatus according to Aspect 6, the circuitry controls the vacuum pump to suck the gas in response to the discharge amount exceeding a predetermined threshold.

### Aspect 14

In the liquid discharge apparatus according to Aspect 13, the circuitry controls the vacuum pump to suck the gas in response to the discharge amount of the liquid discharged from both outermost nozzles of the multiple nozzles in a longitudinal direction orthogonal to the discharge direction, the discharge amount exceeding the predetermined threshold.

### Aspect 15

A liquid discharge head includes a nozzle plate and a suction plate attached to the nozzle plate. The nozzle plate has multiple nozzles to discharge a liquid in a discharge direction. The suction plate has multiple suction holes to suck gas in a suction direction opposite to the discharge direction.

As described above, according to one aspect of the present disclosure, the deviation of the landing position of the liquid can be reduced.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having:
multiple nozzles to discharge a liquid in a discharge direction; and
multiple suction holes to suck gas in a suction direction opposite to the discharge direction.

2. The liquid discharge head according to claim 1,
wherein the nozzle plate has the multiple nozzles on a nozzle face of the nozzle plate, and
the multiple nozzles are arrayed in a longitudinal direction orthogonal to the discharge direction.

3. The liquid discharge head according to claim 2,
wherein the nozzle plate further has other multiple nozzles on a nozzle face of the nozzle plate, and
said other multiple nozzles are arrayed parallel to the multiple nozzles and in the longitudinal direction.

4. The liquid discharge head according to claim 2,
wherein the multiple suction holes are:
adjacent to the multiple nozzles in the longitudinal direction and a transverse direction orthogonal to the longitudinal direction and the discharge direction; and
outside the multiple nozzles in the longitudinal direction and the transverse direction.

5. The liquid discharge head according to claim 2,
wherein the multiple suction holes are disposed outside each of outermost nozzles of the multiple nozzles in the longitudinal direction.

6. The liquid discharge head according to claim 2,
wherein the multiple suction holes surround entire circumference of the multiple nozzles arrayed on the nozzle face of the nozzle plate.

7. A head module comprising multiple liquid discharge heads including the liquid discharge head according to claim 1.

8. A liquid discharge apparatus comprising:
the liquid discharge head according to claim 1, to discharge the liquid to a medium; and
a conveyor to convey the medium to the liquid discharge head.

9. A liquid discharge apparatus comprising:
the liquid discharge head according to claim 1;
a vacuum pump to suck the gas from the multiple suction holes; and
circuitry configured to control the vacuum pump to suck the gas from the multiple suction holes.

10. The liquid discharge apparatus according to claim 9,
wherein the circuitry is further configured to:
control the vacuum pump to suck the gas from the multiple suction holes; or
control the vacuum pump not to suck the gas from the multiple suction holes,
based on a discharge amount of the liquid discharged from the multiple nozzles.

11. The liquid discharge apparatus according to claim 9,
wherein the liquid discharge head includes a driver to discharge the liquid from the multiple nozzles.

12. The liquid discharge apparatus according to claim 11,
wherein the circuitry is further configured to control the driver to discharge the liquid from the multiple nozzles.

13. The liquid discharge apparatus according to claim 9,
wherein the circuitry is further configured to control the vacuum pump to suck the gas to cancel an airflow generated by the liquid discharged from the multiple nozzles.

14. The liquid discharge apparatus according to claim 10,
wherein the circuitry is further configured to control the vacuum pump to suck the gas in response to the discharge amount exceeding a predetermined threshold.

15. The liquid discharge apparatus according to claim 14,
wherein the circuitry is further configured to control the vacuum pump to suck the gas in response to the discharge amount of the liquid discharged from both outermost nozzles of the multiple nozzles in a longitudinal direction orthogonal to the discharge direction, the discharge amount exceeding the predetermined threshold.

16. A liquid discharge head comprising:
a nozzle plate having multiple nozzles to discharge a liquid in a discharge direction; and
a suction plate:
attached to the nozzle plate; and
having multiple suction holes to suck gas in a suction direction opposite to the discharge direction.
